(19) United States
(12) Patent Application Publication
(10) Pub. No.: US 2017/0337430 A1
(43) Pub. Date: Nov. 23, 2017

(54) BAE BABY MONITOR WATCH SYSTEMS

(71) Applicant: Matthew Lattouf, Ajax (CA)

(72) Inventor: Matthew Lattouf, Ajax (CA)

(21) Appl. No.: 15/158,145

(22) Filed: May 18, 2016

(51) Int. Cl. G06K 9/00; G04G 21/04; G06F 3/16; H04N 5/33

(52) U.S. Cl. CPC G06K 9/00771; H04N 5/33; G04G 21/04; G06F 3/16

(57) ABSTRACT

A BAE baby monitor watch system for ‘freeing up’ a user's mobility while being able to remotely monitor a sleeping child. A BAE baby monitor watch system is a combination of an infrared camera and temperature sensor that monitor a sleeping child located in one room while transmitting information to a watch or a docking station located in separate rooms. The watch contains a first display mechanism for observing a child and a speaker for listening to sound generated by the child. The display and sound functions are duplicated in the docking station. The docking station automatically transfers display and sound when the watch is aligned via magnetic coupling devices. The docking station includes a power port that is used to charge the watch. The infrared camera wirelessly transmits sound, images, and temperature to the watch or docking station.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of communications and more specifically relates to baby monitors.

### 2. Description of Related Art

Babies, infants, and small children are in constant need of monitoring in order to ensure their health and well being. Parents often cannot monitor the child in person full time and therefore rely on monitors to free them up in order to perform daily tasks. This is especially true when a child is sleeping.

Portable monitoring devices enable a parent to monitor a child through a communication link. Wearable, portable devices further enable a parent to freely perform daily tasks while monitoring a child's condition. Further information such as room temperature is also a desired monitored condition. A suitable, portable, wearable solution for monitoring a child and room temperature is desired.

Several attempts have been made to solve the above-mentioned problems such as those found in U.S. Pat. No. 5,512,880 to Abrams et. al; U.S. Pub No 274,104 to Khan; U.S. Pub No 2015/0109126A1 to Crawford; and CA204331308 to Beijing-Yuanda Technology Co., Ltd. This art is representative of baby monitors. However, none of the above inventions and patents, taken either singly or in combination, is seen to describe the invention as claimed.

Preferably, a baby monitor watch system should provide the ability to effectively monitor a sleeping child and, yet would operate reliably and be manufactured at a modest expense. Thus, a need exists for a reliable baby monitor watch system to avoid the above-mentioned problems.

### BRIEF SUMMARY OF THE INVENTION

In view of the foregoing disadvantages inherent in the known baby monitor means art, the present invention provides a novel baby monitor watch system. The general purpose of the present invention, which will be described subsequently in greater detail is to provide a portable, wearable device for monitoring a child useful for ensuring the child's health as well as enabling freedom of movement to the user for performing daily tasks.

A baby monitor system is disclosed herein, in a preferred embodiment, comprising: a BAE baby monitor watch assembly comprising a watch; a docking station; and a wall mountable infrared camera assembly. The watch comprises a first speaker, a vibrating mechanism, a first display mechanism, electronic control, at least three control buttons, a first set of magnetic coupling devices, a magnetic proximity charging receiver, a wireless interface, a removable watchband, and a rechargeable power source.

The docking station comprises a support structure further comprising a docking station base, a support arm, and a second display mechanism. The docking station base comprises a combination power port and battery charger and an electronic charging mechanism. The support arm comprises a magnetic charging transmitter and a second set of magnetic coupling devices. The second display mechanism comprises a second speaker, at least one multifunction button, and at least two sets of upper and lower control buttons.

The wall mountable infrared camera assembly comprises an infrared camera system and a camera support base. The infrared camera system further comprises a temperature sensor and an infrared camera. The infrared camera comprises a wireless communication link, a threaded male mounting connector, and sound recording capability. The camera support base comprises a proximate end, a center arm, and a distal end. The distal end comprises a threaded female mounting receiver. Certain embodiments have the capability of manipulating the camera to a wide angle view.

The present invention holds significant improvements and serves as a BAE baby monitor watch system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, BAE baby monitor watch system, constructed and operative according to the teachings of the present invention.

FIG. 1 shows a perspective view illustrating a BAE baby monitor watch system during an ‘in-use’ condition showing a user observing a sleeping child according to an embodiment of the present invention.

FIG. 2 is a perspective view illustrating a BAE baby monitor watch assembly comprising a watch and docking station according to an embodiment of the present invention of FIG. 1.

FIG. 3 is a perspective view illustrating the BAE baby monitor watch assembly illustrating the watch according to an embodiment of the present invention of FIGS. 1-2.

FIG. 4 is a perspective view illustrating the BAE baby monitor watch assembly illustrating the rear of the watch and the upper portion of the docking station according to an embodiment of the present invention of FIGS. 1-3.

FIG. 5A is a perspective view illustrating the BAE baby monitor watch assembly illustrating the infrared camera system according to an embodiment of the present invention of FIGS. 1-4.

FIG. 5B is a perspective view illustrating the BAE baby monitor watch assembly illustrating the infrared camera system according to an embodiment of the present invention of FIGS. 1-4.

FIG. 5C is a perspective view illustrating the BAE baby monitor watch assembly illustrating the infrared camera system according to an embodiment of the present invention of FIGS. 1-4.

FIG. 6 is a flowchart illustrating a method of use for the BAE baby monitor watch system according to an embodiment of the present invention of FIGS. 1-5C.

The various embodiments of the present invention will hereinafter be described in conjunction with the appended drawings, wherein like designations denote like elements.

### DETAILED DESCRIPTION

As discussed above, embodiments of the present invention relate to a baby monitor and more particularly to a BAE baby monitor watch system as used to improve the freedom and mobility of a user while caring for a sleeping child.

Generally speaking, a BAE baby monitor watch system is a combination of an infrared camera and temperature sensor that monitor a sleeping child located in one room while transmitting information to a watch or a docking station located in separate rooms.

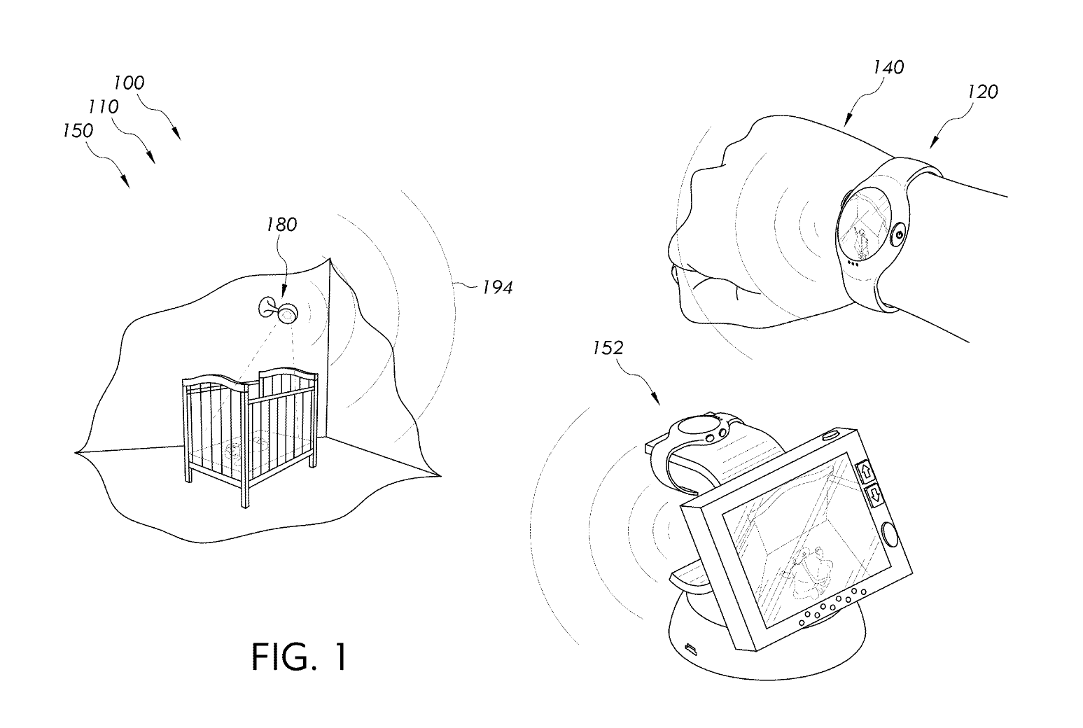

Referring to the drawings by numerals of reference there is shown in FIG. 1, illustrates a BAE baby monitor watch system 100 comprising a BAE baby monitor watch assembly 110 during an ‘in-use’ condition 150. BAE baby monitor watch assembly 110 includes a watch 120, a docking station 152, and a wall mountable infrared camera assembly 180.

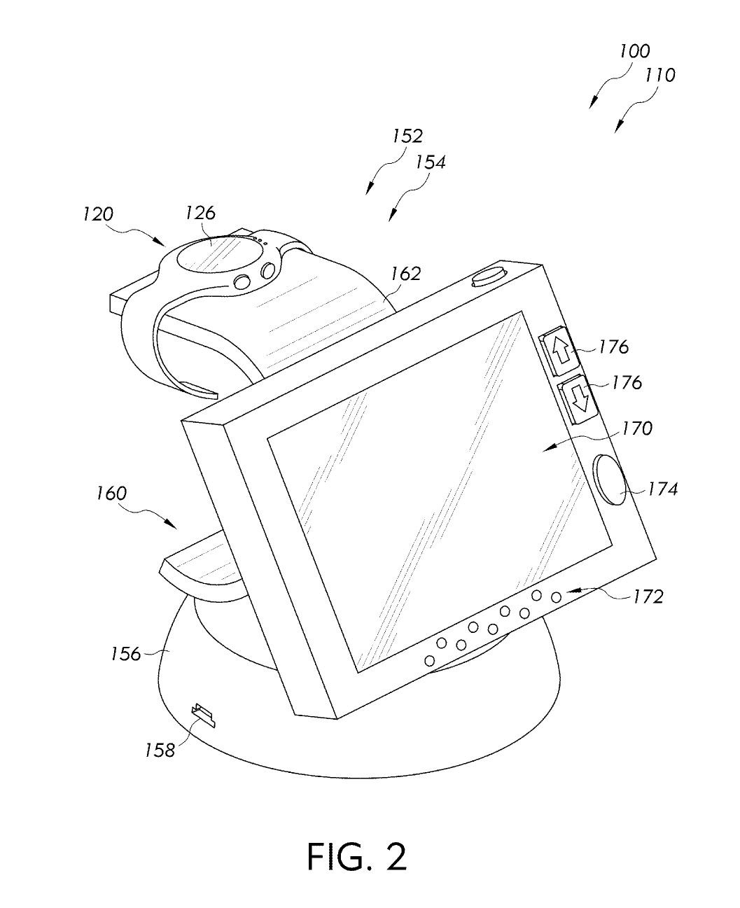

Referring now to FIG. 2, illustrating docking station 152 comprising a support structure 154 and a second display mechanism 170. Docking station 152 includes a docking station base 156, a support arm 162, and a second display mechanism 170 in functional combination for supporting and recharging watch 120 as well as providing a second monitoring mechanism. Station base 156 includes a combination power port and battery charger 158 and an electronic charging mechanism 160 that is electrically connected to magnetic charging transmitter 164. Support arm 162 also includes a second display mechanism 170 and a second speaker 172 for monitoring a sleeping child. Second display mechanism 170 is capable of displaying room temperature from wall mountable infrared camera assembly 180. At least two sets of upper and lower control buttons 176 are used to select monitoring settings via second display mechanism 170. One set of two sets of upper and lower control buttons 176 is used to control volume for second speaker 172. Second set of two sets of upper and lower control buttons 176 is used to control dimming of second display mechanism 170.

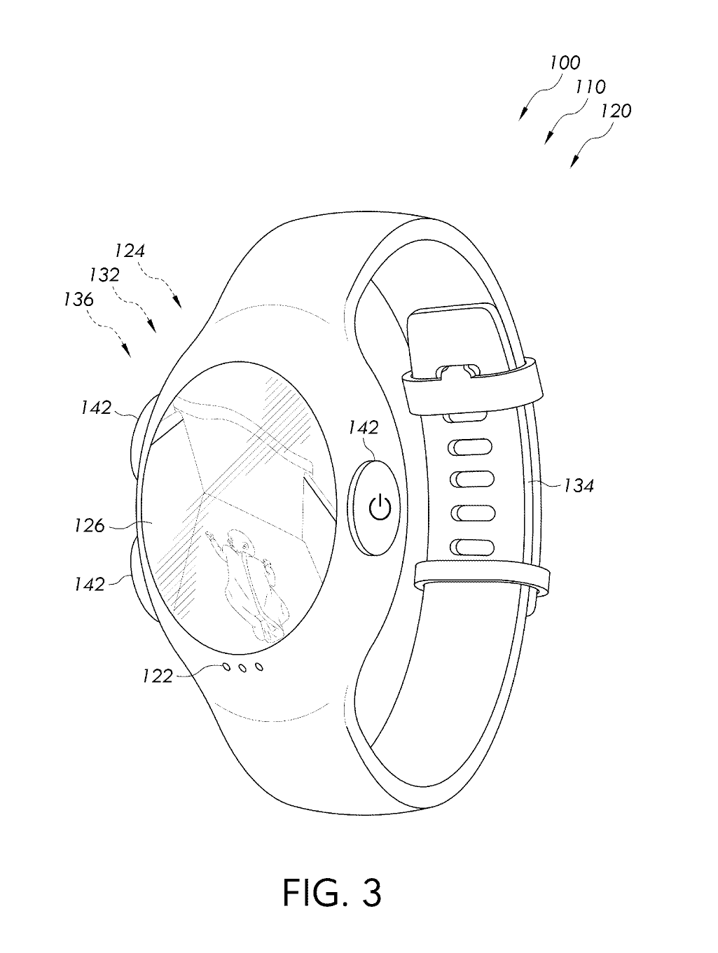

Referring now to FIG. 3, watch 120 includes a first speaker 122, a vibrating mechanism 124, a first display mechanism 126, electronic control 138, at least three control buttons 142, a first set of magnetic coupling devices 128; a magnetic proximity charging receiver 130; a wireless interface 132, a removable watchband 134, and a rechargeable power source 136 together in functional combination. First speaker 122, vibrating mechanism 124, and first display mechanism 126 enable user 140 to monitor a sleeping child via electronic control 138.

At least three control buttons 142 are usable for switching power to watch 120, initiating the first display mechanism 126, and controlling watch 120 volume. First display mechanism 126 automatically dims via electronic control 138. First display mechanism 126 displays the image transmitted from wall mountable infrared camera assembly 180 by wireless interface 132. Watch 120 is of a waterproof design and includes removable watchband 134 and a rechargeable power source 136 for powering watch 120. At least three multifunction buttons 142 are able to be depressed for a predetermined amount of time to power OFF said first display mechanism 126, initiate vibrate mode via vibrating mechanism 124, and control watch volume. Vibrating mechanism 124 includes an activation mode by tapping twice on one of at least three multifunction buttons 142. First display mechanism 126 indicates a low battery condition.

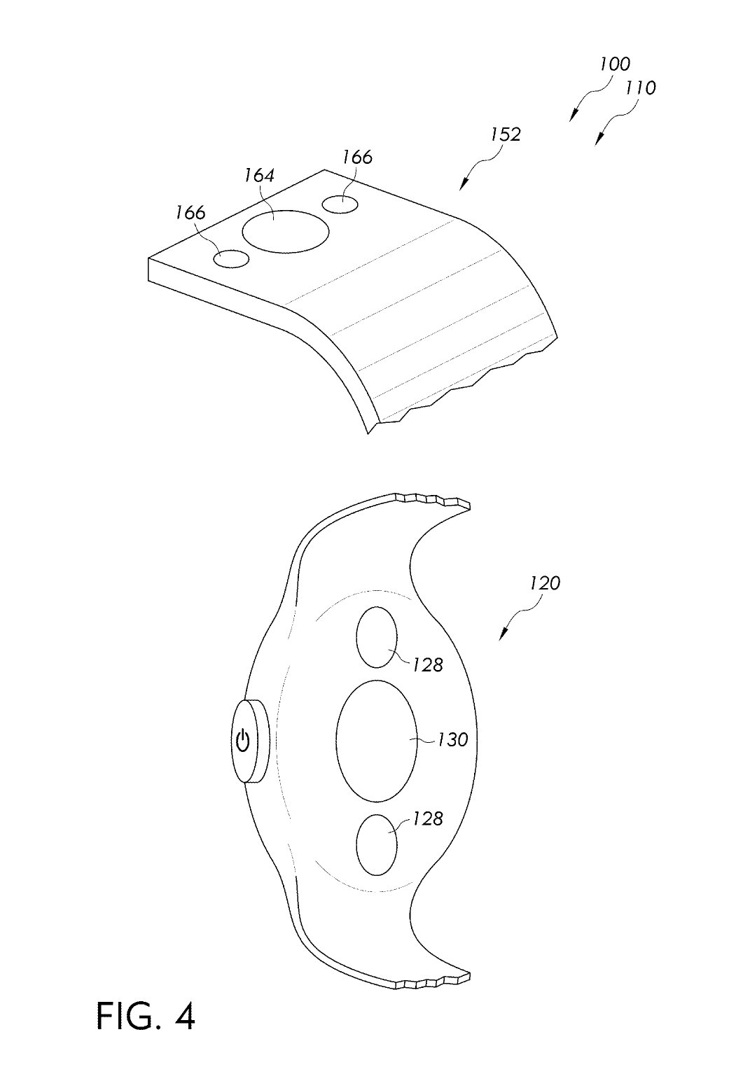

Referring now to FIG. 4, a view of support arm 162 shows how a first set of magnetic coupling devices 128 align the watch 120 with second set of magnetic coupling devices 166 and magnetic proximity charging receiver 130 for the purpose of recharging the watch 120 via electronic charging mechanism 160. Support arm 162 includes a magnetic charging transmitter 164 for recharging watch 120 via a magnetic coupling between a magnetic proximity charging receiver 130 and magnetic charging transmitter 164. Docking station 152 automatically detects and switches control from watch 120 and first display mechanism 126 to second display mechanism 170 when first set of magnetic coupling devices 128 is detected by second set of magnetic coupling devices 166.

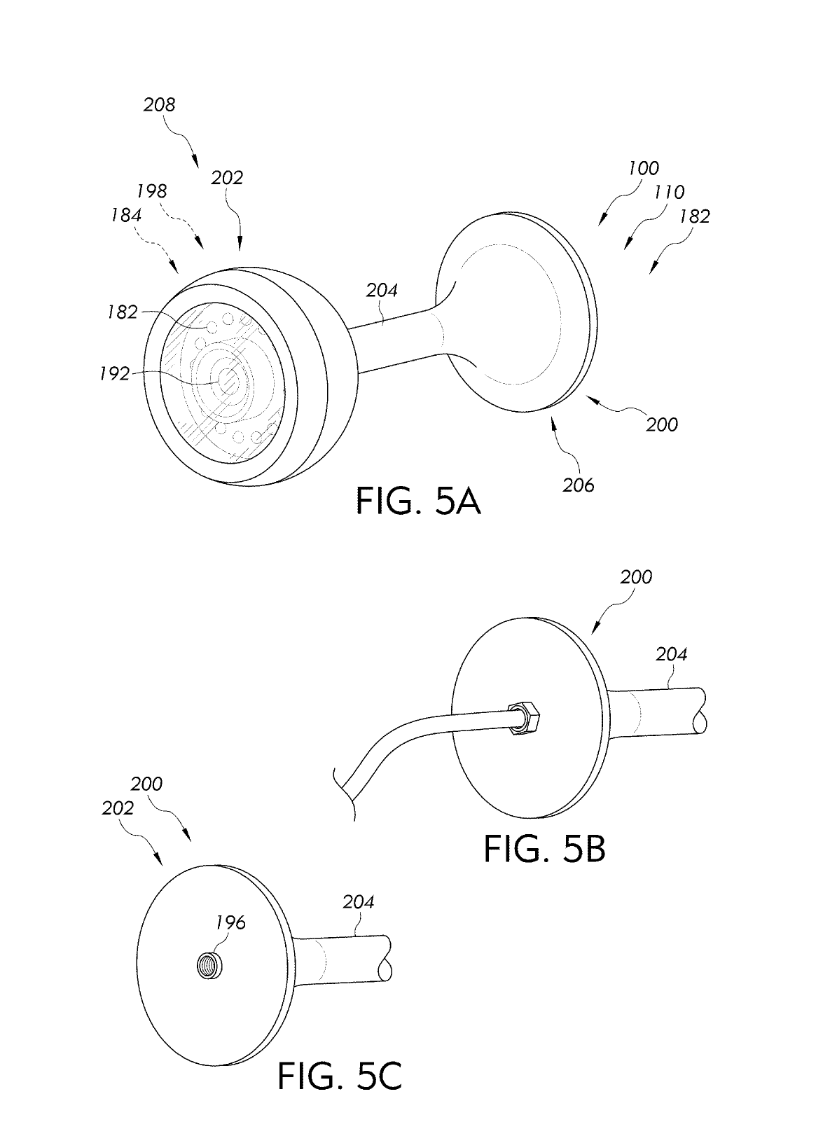

Referring now to FIG. 5A, a wall mountable infrared camera assembly 180 comprising an infrared camera system 182 and a camera support base 200 is shown. Infrared camera system 182 includes a temperature sensor 184 and an infrared camera 192 with sound recording capability 198. Infrared camera 192 includes a wireless communication link 194 for communicating with watch 120 and docking station 152.

Referring now to FIGS. 5A-5C, infrared camera 192 includes a threaded male mounting connector 196 for removably coupling infrared camera 192 to threaded female mounting receiver 208; located in distal end 206 of camera support base 200. Camera support base 200 includes proximate end 202, center arm 204, and distal end 206 together in structural combination for supporting or mounting wall mountable infrared camera assembly 180. In the preferred embodiment, distal end 206 can be wall mounted. For alternate embodiments, distal end 206 can be placed on a flat surface to support infrared camera system 182. In the preferred embodiment, infrared camera system 182 uses a rechargeable power source 136. In alternate embodiments, infrared camera system 182 uses a wired power source.

BAE baby monitor watch system 100 may be sold as kit 440 comprising the following parts: at least one BAE baby monitor watch assembly 110 and at least one set of user instructions. The kit has instructions such that functional relationships are detailed in relation to the structure of the invention (such that the invention can be used, maintained, or the like in a preferred manner). BAE baby monitor watch system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different communication means and combinations, parts may be sold separately, etc., may be sufficient.

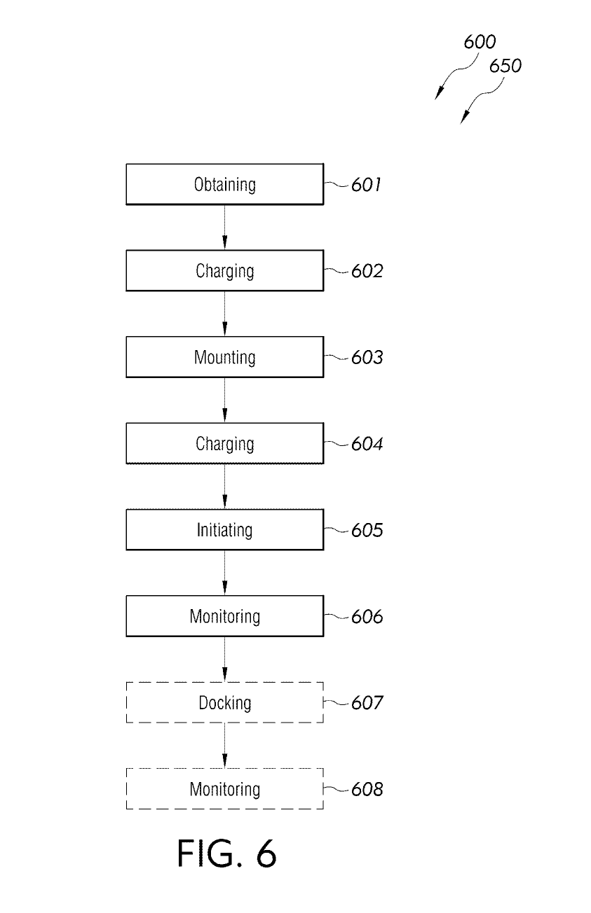

Referring now to FIG. 6 showing flowchart 650 illustrating method of use 600 for BAE baby monitor watch system 100 according to an embodiment of the present invention of FIGS. 1-5.

As shown, method of use 600 may comprise the steps of: step one 601, obtaining BAE baby monitor watch system 100, step two 602, charging infrared camera 192, step three 603, mounting infrared camera 192, step four 604, charging watch 120, step five 605, initiating BAE baby monitor watch system 100, step six 606, monitoring BAE baby monitor watch system 100, step seven 607, docking watch 120 in docking station 152, step eight 608, monitoring BAE baby monitor watch system 100.

It should be noted that steps 607 and 608 are optional steps and may not be implemented in all cases. Optional steps of method of use 600 are illustrated using dotted lines in FIG. 6 so as to distinguish them from the other steps of method of use 600.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A BAE baby monitor watch system comprising:
a BAE baby monitor watch assembly comprising:
a watch comprising:
a first speaker;
a vibrating mechanism;
first display mechanism;
electronic control;
at least three control buttons;
a first set of magnetic coupling devices;
a magnetic proximity charging receive;
a wireless interface;
removable watchband; and
a rechargeable power source;
a docking station comprising:
a support structure comprising:
a docking station base comprising:
a combination power port and battery charger;
an electronic charging mechanism;
a support arm comprising:
a magnetic charging transmitter;
a second set of magnetic coupling devices;
a second display mechanism comprising:
a second speaker;
at least one multifunction button; and
at least two sets of upper and lower control buttons;
a wall mountable infrared camera assembly comprising:
an infrared camera system comprising:
a temperature sensor;
an infrared camera comprising:
a wireless communication link;
a threaded male mounting connector; and
sound recording capability;
a camera support base comprising:
a proximate end;
a center arm;
a distal end comprising; and
a threaded female mounting receiver;
wherein said BAE baby monitor watch system comprises BAE baby monitor watch assembly;
wherein said BAE baby monitor watch assembly comprises said watch, and said docking station together in functional combination;
wherein said watch comprises said first speaker, said vibrating mechanism, said first display mechanism, electronic control, said at least three control buttons, said first set of magnetic coupling devices; said magnetic proximity charging receiver; said wireless interface, said removable watchband, and said rechargeable power source together in functional combination;
wherein said docking station comprises said support structure and said second display mechanism together in functional combination;
wherein said second display mechanism is rigidly affixed to said support arm;
wherein said support structure comprises said base and said support arm together in functional combination;
wherein said docking station base comprises said combination power port and said electronic charging mechanism together in functional combination;
wherein said support arm comprises said magnetic charging transmitter and said second set of magnetic coupling devices together in functional combination;
wherein said first set of magnetic coupling devices and said second set of magnetic coupling devices enable a removably couplable connection of said watch to said support arm;
wherein said combination power port and battery charger is electrically coupled to said magnetic charge transmitter;
wherein said second display mechanism comprises: said second speaker. at least one multifunction button, and said at least two sets of upper and lower control buttons together in functional combination;
wherein said magnetic charging transmitter is capable of sensing the presence of said magnetic charging receiver;
wherein said magnetic charging transmitter triggers a transfer of display function from first display mechanism to second display mechanism upon sensing the presence of said magnetic charging receiver;
wherein said first display mechanism automatically dims via electronic control;
wherein said wall mountable infrared camera assembly comprises said infrared camera system and said camera support base together in functional combination;
wherein said infrared camera system comprises said temperature sensor, said infrared camera, said threaded male mounting connector, and said wireless communication link together in functional combination;
wherein said camera support base comprises said proximate end, said center arm, and said distal end together in functional combination;
wherein said distal end comprises said threaded female mounting receiver;
wherein said threaded male mounting connector is removably couplable to said threaded female mounting receiver; and
wherein said BAE baby monitor watch assembly is structured and arranged to provide a user with a device useful for monitoring a child via a watch and alternately a docking station.

2. The BAE baby monitor watch system of claim 1 wherein said first set of magnetic coupling devices and said second set of magnetic coupling devices are arranged in a manner for aligning said watch to said support arm.

3. The BAE baby monitor watch system of claim 1 wherein said proximate end of said camera support base is wall mountable.

4. The BAE baby monitor watch system of claim 1 wherein said proximate end of said camera support base is able to support said wall mountable infrared camera assembly when placed on a flat surface.

5. The BAE baby monitor watch system of claim 1 wherein said infrared camera system uses a rechargeable power source.

6. The BAE baby monitor watch system of claim 1 wherein said infrared camera system uses a wired power source.

7. The BAE baby monitor watch system of claim 1 wherein said at least one multifunction button is used to power said second display mechanism.

8. The BAE baby monitor watch system of claim 7 wherein said at least one multifunction button is depressed for a predetermined amount of time to power OFF said second display mechanism.

9. The BAE baby monitor watch system of claim 1 wherein said at least three control buttons initiates vibrate mode by double tapping.

10. The BAE baby monitor watch system of claim 1 wherein said at least three control buttons control watch volume.

11. The BAE baby monitor watch system of claim 1 wherein said watch is of a waterproof design.

12. The BAE baby monitor watch system of claim 1 wherein said display mechanisms are capable of displaying images and projecting sound from said infrared camera system.

13. The BAE baby monitor watch system of claim 1 wherein said first display mechanism indicates a low battery condition.

14. The BAE baby monitor watch system of claim 1 wherein one set of said two sets of upper and lower control buttons is used to control volume.

15. The BAE baby monitor watch system of claim 1 wherein one set of said two sets of upper and lower control buttons is used to control display dimming.

16. The BAE baby monitor watch system of claim 1 temperature sensor is used to display ambient temperature via said display mechanisms.

17. A BAE baby monitor watch system comprising:
a BAE baby monitor watch assembly comprising:
a watch comprising:
a first speaker;
a vibrating mechanism;
first display mechanism;
electronic control;
at least three control buttons;
a first set of magnetic coupling devices;
a magnetic proximity charging receiver;
a wireless interface;
removable watchband; and
a rechargeable power source;
a docking station comprising:
a support structure comprising:
a docking station base comprising:
a combination power port and battery charger; and
an electronic charging mechanism;
a support arm comprising:
a magnetic charging transmitter; and
a second set of magnetic coupling devices;
a second display mechanism comprising:
a second speaker;
at least one multifunction button; and
at least two sets of upper and lower control buttons;
a wall mountable infrared camera assembly comprising:
an infrared camera system comprising:
a temperature sensor;
an infrared camera comprising:
a wireless communication link;
a threaded male mounting connector; and
a sound recording capability;
a camera support base comprising:
a proximate end;
a center arm;
a distal end comprising; and
a threaded female mounting receiver;
wherein said BAE baby monitor watch system comprises BAE baby monitor watch assembly;
wherein said BAE baby monitor watch assembly comprises said watch, and said docking station together in functional combination;
wherein said watch comprises said first speaker, said vibrating mechanism, said first display mechanism, electronic control, said at least three control buttons, said first set of magnetic coupling devices; said magnetic proximity charging receiver; said wireless interface, said removable watchband, and said rechargeable power source together in functional combination;
wherein said docking station comprises said support structure and said second display mechanism together in functional combination;
wherein said second display mechanism is rigidly affixed to said support arm;
wherein said support structure comprises said docking station base and said support arm together in functional combination;
wherein said docking station base comprises said combination power port and said electronic charging mechanism together in functional combination;
wherein said support arm comprises said magnetic charging transmitter and said second set of magnetic coupling devices together in functional combination;
wherein said first set of magnetic coupling devices and said second set of magnetic coupling devices enable a removably couplable connection of said watch to said support arm;
wherein said combination power port and battery charger is electrically coupled to said magnetic charge transmitter;
wherein said first display mechanism automatically dims via electronic control;
wherein said second display mechanism comprises: said second speaker. at least one multifunction button, and said at least two sets of upper and lower control buttons together in functional combination;
wherein said magnetic charging transmitter is capable of sensing the presence of said magnetic charging receiver;
wherein said magnetic charging transmitter triggers a transfer of display function from first display mechanism to second display mechanism upon sensing the presence of said magnetic charging receiver;
wherein said wall mountable infrared camera assembly comprises said infrared camera system and said camera support base together in functional combination;
wherein said infrared camera system comprises said temperature sensor, said infrared camera, said threaded male mounting connector, and said wireless communication link together in functional combination;
wherein said camera support base comprises said proximate end, said center arm, and said distal end together in functional combination;
wherein said distal end comprises said threaded female mounting receiver;
wherein said threaded male mounting connector is removably couplable to said threaded female mounting receiver;
wherein said BAE baby monitor watch assembly is structured and arranged to provide a user with a device useful for monitoring a child via a watch or a docking station;
wherein said first set of magnetic coupling devices and said second set of magnetic coupling devices are arranged in a manner for aligning said watch to said support arm;
wherein said proximate end of said camera support base is wall mountable;
wherein said proximate end of said camera support base is able to support said wall mountable infrared camera assembly when placed on a flat surface;
wherein said infrared camera system uses a rechargeable power source;
wherein said at least one multifunction button is used to power said second display mechanism;
wherein said at least one multifunction button is depressed for a predetermined amount of time to power OFF said second display mechanism;
wherein said at least three control buttons initiates vibrate mode by double tapping;
wherein said at least three control buttons control watch volume;
wherein said watch is of a waterproof design;
wherein said display mechanisms are capable of displaying images and projecting sound from said infrared camera system;
wherein said first display mechanism indicates a low battery condition;
wherein one set of said two sets of upper and lower control buttons is used to control volume;
wherein one set of said two sets of upper and lower control buttons is used to control display dimming; and
wherein said temperature sensor is used to display ambient temperature via said display mechanisms.

18. The BAE baby monitor watch system of claim 17 further comprising a kit including:
said BAE baby monitor watch assembly and a set of instructions.

19. A method of using a BAE baby monitor watch system comprising the steps of:
obtaining a BAE baby monitor watch system;
charging an infrared camera mounting infrared camera;
charging a watch;
initiating said BAE baby monitor watch system; and
monitoring said BAE baby monitor watch system.

20. The method of claim 19 further comprising the steps of:
docking said watch; and
monitoring said BAE baby monitor watch system.
